(19) United States
(12) Patent Application Publication
(10) Pub. No.: US 2015/0147732 A1
(43) Pub. Date: May 28, 2015

(54) Method For Achieving Positive Mental Outlook For Wholesome And Better Living

(71) Applicant: Anand K. Chavakula, Silver Spring, MD (US)

(72) Inventor: Anand K. Chavakula, Silver Spring, MD (US)

(21) Appl. No.: 14/553,735

(22) Filed: Nov. 25, 2014

Related U.S. Application Data
(60) Provisional application No. 61/963,152, filed on Nov. 25, 2013.

(51) Int. Cl. G09B 19/00

(52) U.S. Cl. CPC G09B 19/003
USPC 434/236

(57) ABSTRACT

A system and method to follow for sound body and mind consisting of four steps that are followed over a four week period. Each week comprises a different focus and after the allotted time period the user has completed the method. The system focuses on the wellness of body, mind and spirit and the connection between both physical and mental wellbeing as well as the local community a person may live in through engaging in outreach or community service related programs.

### PRIORITY CLAIM

This application claims priority from Provisional Patent Application No. 61/963,152, filed Nov. 25, 2013 whose contents are incorporated herein in its entirety for all purposes.

### FIELD OF THE DISCLOSURE

This disclosure relates to a lifestyle management system, and more particularly to facilitating one's well-being by following a four step approach and or over a four week period with the goal of achieving betterment in one's life and prepare for life to come or hereafter

The formula for this approach incorporates: 1. Mind, 2. Body, 3. Spirit, and 4. Community interaction each of one week over a four week period. This is repeated thus every month. The formula is also meant to be understood easily or instantly in the way the graphics or representative elements are arranged on a website.

### BACKGROUND OF THE DISCLOSURE

Better living can be promoted in various aspects. It is the unique combination of various activities and or study that leads to well being. Accordingly, with the use of the internet, methods for better living that are created today can be easily implemented and organized into well laid out steps that are easily adhered to by an end user.

As a way to promote better living or wholesome living the method described herein is a unique 4 step approach over a four week period that has not been created to date in such a simple and easy way to follow. Accordingly, there is a need for a method for facilitating better living in a simple and easy to follow format.

### SUMMARY OF THE DISCLOSURE

The present disclosure addresses the above-described need by providing a method for optimizing better living.

In an exemplary embodiment of the present invention, there is disclosed a method that is divided into a four step approach. The four steps are:

1. Mind

2. Body

3. Spirit

4. Community

According to one aspect of the disclosure, the method includes four main areas of concentration through which the message of wholeness or wholesome living or better living is communicated with guidelines one can follow. By using the internet to convey the method, each area is broken down into a related subpage which shows a video player on the top side of each sub webpage or channel. This embedded web based video player shows either live broadcast content or recorded content. Anyone can listen and interact socially on these three or four main subpages or channels to the specific topics that are related to each channel or subpage.

The four channels are grouped and themed as follows:

Channel or Button/Tab 1 is named as MIND or anything related to this tab or sub webpage. MIND (Social Matters): On this subpage or channel, content that deals with “loving others” and understanding the world around a typical person like relationship or social issues, politics, science, technology, environment etc. are presented for discussion and interaction with the aim toward helping people develop a better relationship with the world around. This tab or channel can be called anything else that deals with the topics mentioned. Also, it will be easy for a person to simply enter the web address by first typing the main domain name like “hopeside.org” and then a forward slash can be entered after the internet domain name and then the word “mind” can be entered and then the “ENTER” or “GO” button or key of a computer or mobile device's keyboard can tapped or clicked and a person can land on the “MIND” subpage or channel where the video player is instantly visible to watch and interact or related content. Alternatively, another way to enter the web address of this page can as follows where the sub channel name can be entered followed by a dot and then followed by a the main domain name i.e., mind.hopeside.org. Also, HopeSide Ministries, dedicates the first week of any month to present topics on this theme offline in its meetings as an example of how it promotes its messages regularly.

Channel or Button/Tab 2 is named as BODY or anything related to this tab or sub webpage. BODY (Health Matters): On this subpage or channel, content that deals with “loving oneself” or health related topics, medical news, financial matters and such are presented for discussion and interaction with the aim toward helping people develop healthy habits for personal development. This tab or channel can be called anything else that deals with the topics mentioned. Also, it will be easy for a person to simply enter the web address by first typing the main domain name like “hopeside.org” and then a forward slash can be entered after the internet domain name and then the word “body” can be entered and then the “ENTER” or “GO” button or key of a computer or mobile device's keyboard can be tapped or clicked and a person can land on the “BODY” subpage or channel where the video player is instantly visible to watch and interact or any related content. Alternatively, another way to enter the web address of this page can be as follows where the sub channel name can be entered followed by a dot and then followed by a the main domain name i.e., body.hopeside.org. Also, HopeSide Ministries, dedicates the second week of any month to present topics on this theme offline in its meetings as an example of how it promotes its messages regularly

Channel or Button/Tab 3 is named as SPIRIT or anything related to this tab or sub webpage. SPIRIT (Faith Matters): On this subpage or channel, content that deals with “loving God” or faith related topics are presented for discussion and interaction with the aim toward helping people develop a better relationship with the Supreme being that created all things. This tab or channel can be called anything else that deals with the topics mentioned. Also, it will be easy for a person to simply enter the web address by first typing the main domain name like “hopeside.org” and then a forward slash can be entered after the internet domain name and then the word “spirit” can be entered and then the “ENTER” or “GO” button or key of a computer or mobile device's keyboard can be tapped or clicked and a person can land on the “SPIRIT” subpage or channel where the video player is instantly visible to watch and interact. Alternatively, another way to enter the web address of this page can as follows where the sub channel name can be entered followed by a dot and then followed by the main domain name i.e., spirit.hopeside.org. Also, HopeSide Ministries, dedicates the third week of any month to present topics on this theme offline in its meetings as an example of how it promotes its messages regularly.

Channel or Button/Tab 4 is named as COMMUNITY or anything related to this tab or sub webpage. COMMUNITY (Outreach Matters): On this subpage or channel, content that deals with “community outreach” or service or community service related topics are presented for discussion and interaction with the aim toward motivating people to be involved in Christian Outreach and other community outreach related topics. This tab or channel can be called anything else that deals with the topics mentioned. Also, it will be easy for a person to simply enter the web address by first typing the main domain name like “hopeside.org” and then a forward slash can be entered after the internet domain name and then the word “community” can be entered and then the “ENTER” or “GO” button or key of a computer or mobile device's keyboard can be tapped or clicked and a person can land on the “COMMUNITY” subpage or channel where the video player is instantly visible to watch and interact. Alternatively, another way to enter the web address of this page can be as follows where the sub channel name can be entered followed by a dot and then followed by a the main domain name i.e., community.hopeside.org. Also, HopeSide Ministries, dedicates the fourth and fifth week of any month to present topics on this theme offline in its meetings as an example of how it promotes its messages regularly.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing was outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

FIG. 1 schematically illustrates a particular home landing webpage of the system.

FIG. 2 schematically illustrates the “mind” aspect of the system.

FIG. 3 schematically illustrates the “body” aspect of the system, in accordance with an embodiment of the disclosure.

FIG. 4 schematically illustrates the “spirit” aspect of the system, in accordance with another embodiment of the disclosure.

FIG. 5 is a screenshot of a community outreach page displayed to a user detailing how to communicate with likeminded other system users.

FIG. 6 is a screenshot that shows how the method can appear using its HOPESIDE logo appearing in a banner on the webpage.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated devices, and such further applications of the principles of the invention as illustrated therein being contemplated as would normally occur to one skilled in the art to which the invention relates.

Good health and physical fitness are generally associated with each other and various books on exercise and diet programs have been written to help individuals improve their physical fitness. Some books involve eating programs which control a person's caloric or carbohydrate intake, and others are directed toward an exercise that raise a person's heart rate to a predetermined maximum rate for a predetermined time period. Almost all require apparatus in the form of an exercise machine and/or at least one electronic sensor.

What is needed is a method which is simple to use and does not require any apparatus or equipment for determining a person's minimum physical fitness level that works for all body types.

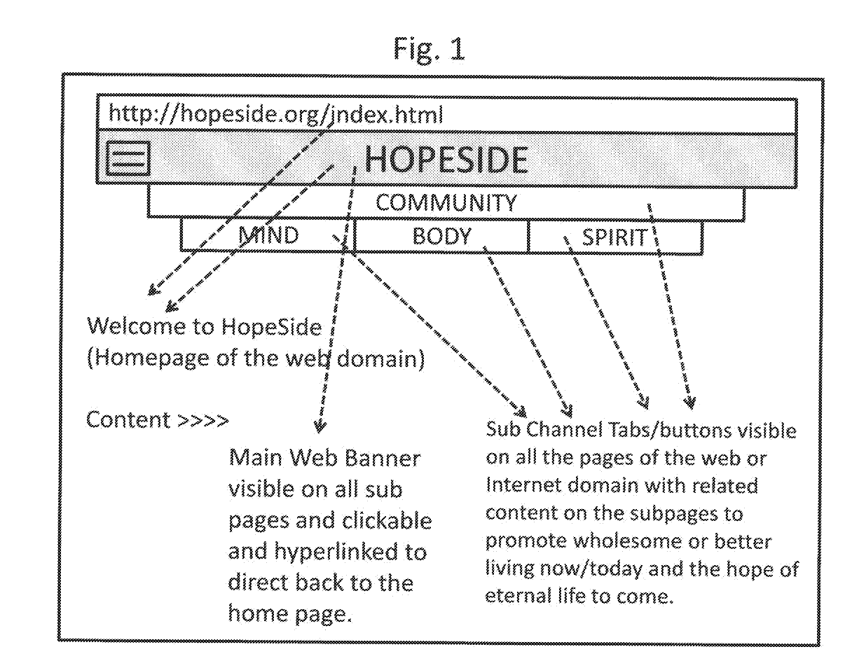

FIG. 1 Shows a webpage layout of the method. There can be three or four links with which to choose from. The method focuses on four areas of improvement over a four week period that can be repeated in the presentation mode online or in offline meetings

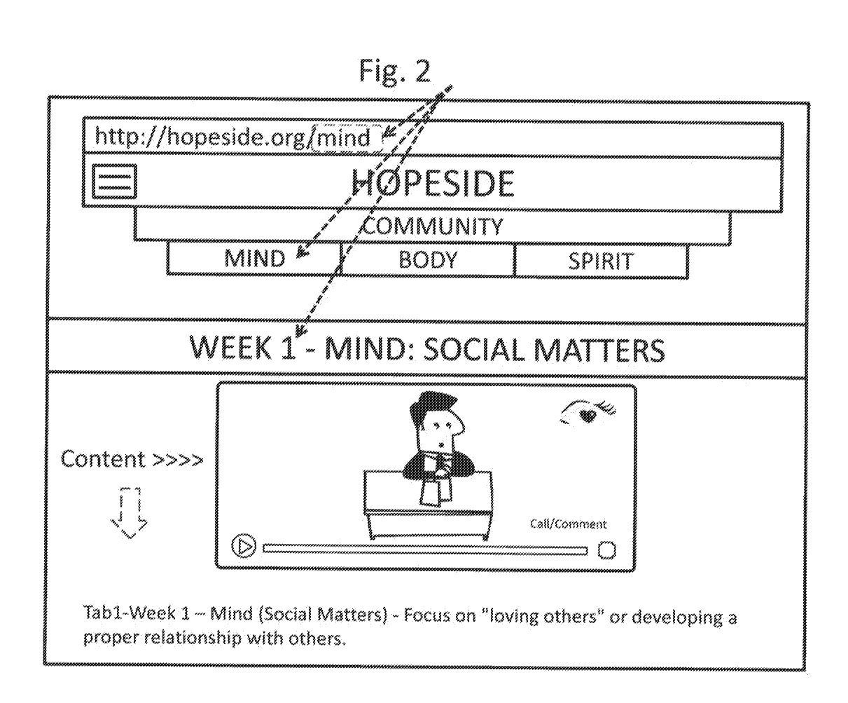

FIG. 2 shows that week one is focused on the mind and social matters therein. Either a video with lecture can be shown or written literature can be provided online in the related web page and read and interacted with through social commentary methods in regards to this topic.

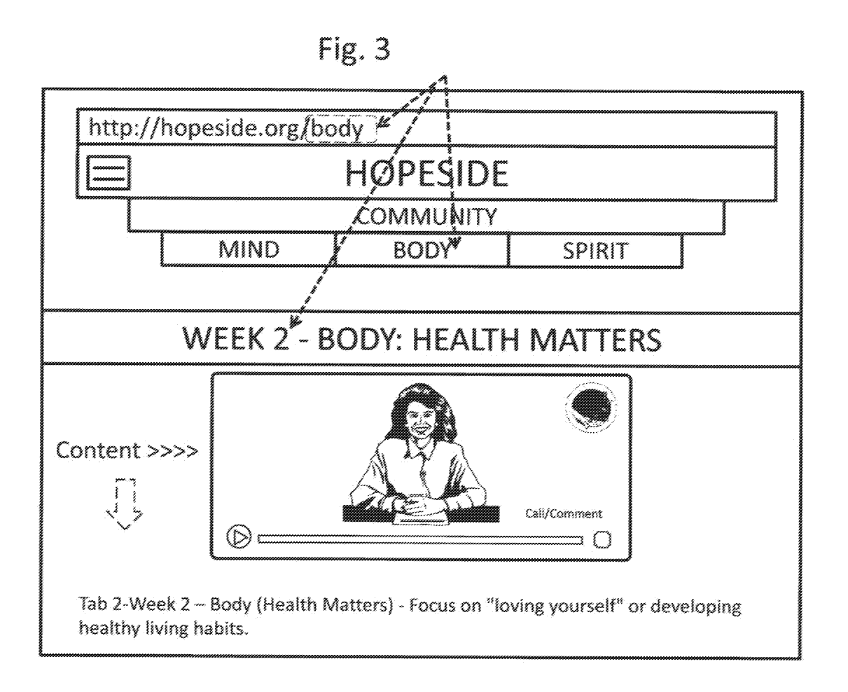

FIG. 3 shows a focus on the body and health matters associated therein. Either a video with lecture can be shown or written literature can be provided online in the related web page and read and interacted with through social commentary methods in regards to this topic.

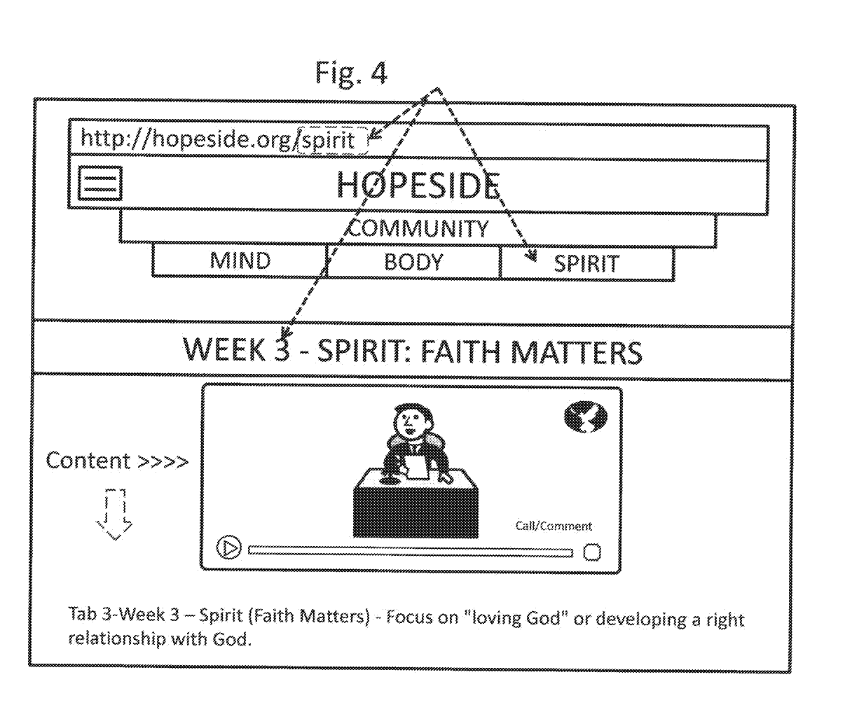

FIG. 4 shows that week 3 focuses on spirit and faith related matter. Either a video with lecture can be shown or written literature can be provided online in the related web page and read and interacted with through social commentary methods in regard to this topic.

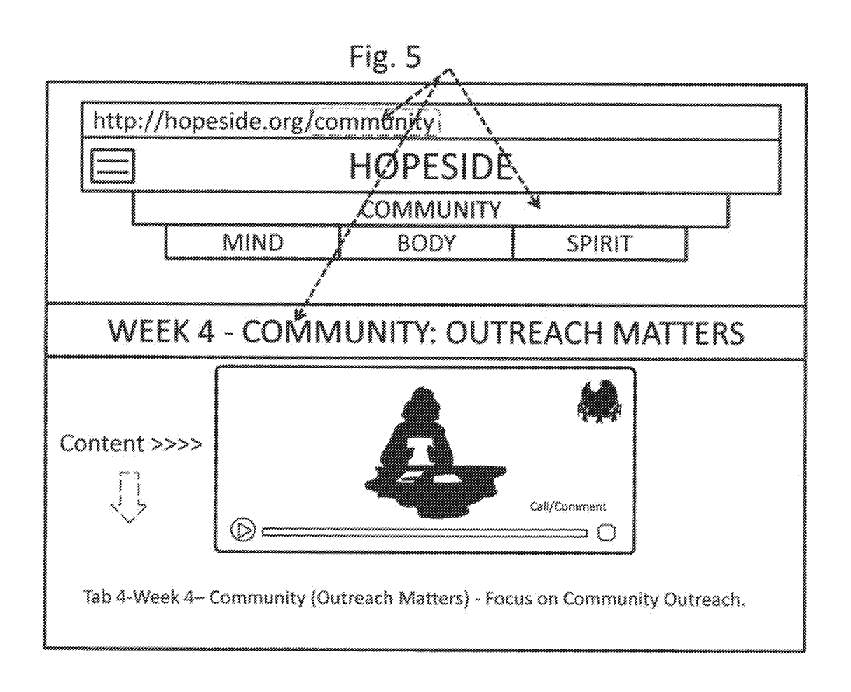

FIG. 5 shows that week 4 focuses on community and outreach or service related matter, Either a video with lecture can be shown or written literature can be provided online in the related web page and read and interacted with through social commentary methods in regard to this topic. It also shows how a community can be set up on a webpage for users of the method to communicate with like minded individuals who are also at the fourth week of the program. It is at this time that they can discuss with each other what they have learned and how the combination of this study over the prior weeks has helped to improve their wellbeing.

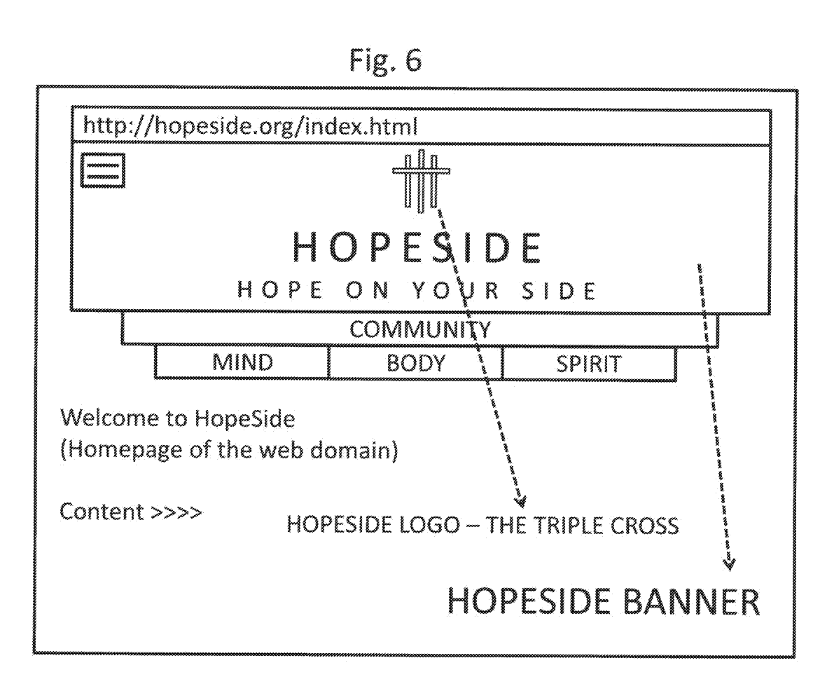

FIG. 6 is a screenshot that shows how the HOPESIDE logo is used as the name of this method appears in a banner on a webpage. A program guide can be prepared as well for printing and or disclosing online or offline these three or four programs under which various topics can be categorized in any order to draw attention to this method of better living or wholesome living and to prepare for life to come. A two point tagline will be used to promote this program which will consist of reference to (a) better living or wholesome living now or today and thus (b) prepare for eternal life to come. The HopeSide logo consists of three vertical lines with the center line longer than the left and right lines. A horizontal line intersects all three lines on the top side which results in the look of a triple cross. This triple cross is called the “HOPESIDE CROSS” which symbolizes the statement “HOPE ON YOUR SIDE” or “HOPE ON OUR SIDE.”

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

1. A method for providing a uniform standard for users to follow to live with a positive outlook on life comprising a focus on 4 topics:
a sound mind; a sound body; a sound spirit; and communication with others to foster building community through various outreach methods.

2. The method according to claim 1, wherein the user focuses on mind thoughts for a one week period.

3. The method according to claim 2, wherein the user focuses on body exercise and related topics for personal advancement for a one week period.

4. The method according to claim 3 wherein the user focuses on spiritual review for a one week period.

5. The method according to claim 4 wherein the user focuses on communicating with others to build a better community for a one week period.
